(19) United States
(12) Patent Application Publication
(10) Pub. No.: US 2013/0083541 A1
(43) Pub. Date: Apr. 4, 2013

(54) OPTICAL LENS, LIGHT-EMITTING DIODE OPTICAL COMPONENT AND LIGHT-EMITTING DIODE ILLUMINATION LAMP

(71) Applicants: Yu-Bin Fang, Tainan City (TW); Chi-Feng Lin, Tainan City (TW); Po-Hua Yang, Tainan City (TW)

(72) Inventors: Yu-Bin Fang, Tainan City (TW); Chi-Feng Lin, Tainan City (TW); Po-Hua Yang, Tainan City (TW)

(21) Appl. No.: 13/251,688

(22) Filed: Oct. 3, 2011

(51) Int. Cl. F21V 5/04

(52) U.S. Cl. 362/311.02; 362/335

(57) ABSTRACT

The invention is related to an optical lens, a light-emitting diode optical component and a light-emitting diode illumination lamp. The optical lens formed as a semi-spherical shape includes an uplifting spherical surface and a bottom surface corresponding to the spherical surface, and the bottom surface includes an inward space concave to the spherical surface and formed with a free surface corresponding to the spherical surface. The free surface is axially-symmetrical formed as rotational molding with respect to an axis connected from the focus to a center point of the spherical surface, to form the free surface with a similar Gaussian distribution curve provided on a section vertically cut from the spherical surface to the bottom surface. A light-emitting diode is disposed below the focus of the optical lens. The special outline structure of the optical lens can provide a uniform luminance distribution on an illuminating area.

### BACKGROUND OF THE INVENTION

1. Field of the Invention

The present invention relates to an optical lens, a light-emitting diode optical component and a light-emitting diode illumination lamp, and in particular relates to an optical lens capable of enabling a high-directional radiant light-emitting diode to emit a uniform scattering light and providing an illuminating area with a uniform luminance distribution, and a light-emitting diode optical component and a light-emitting diode illumination lamp which are equipped with the optical lens.

2. Description of the Related Art

With the increasing of luminous power and heat-dissipation efficiency and the advantages of environmental protection and low power consumption of light-emitting diodes (LEDs), traditional light sources such as fluorescent lamps and incandescent lamps have been gradually replaced by the LEDs. In general, the small-sized and high-directional radiant LEDs cannot directly provide uniform luminance to an environment such as indoor illumination or outdoor illumination, i.e., the LEDs can provide uniform luminance and change light path thereof by incorporating with optical components (e.g., reflection mirror or lens) of secondary optics design.

Taiwan Patent No. 201118428 discloses an optical lens, providing a main body with two opposite ends, wherein the main body has a first surface located on one end and a second surface located on the other end, and a recess is disposed on the first surface of the main body. The recess has a side surface served as a light incident surface for the optical lens, so that the light emitted from the light source can be incident to the main body via the side surface of the recess. The second surface of the main body is a symmetrical aspherical surface served as a light emitting surface for the optical lens. The side surface of the recess and the second surface are utilized to adjust the light emitted from the light source.

Taiwan Patent No. M379029 discloses a light-emitting diode (LED) lamp lens, providing a lens sheet with an exterior composed of an outer side surface and an outer top portion and an interior composed of a first reflective layer, a second reflective layer and a third reflective layer. The LED lamp lens is characterized with convergence angle of aspherical optics to oriently refract and modify the brightness of the light passed therethrough, so that a uniform brightness radiation and light shape can be obtained.

### BRIEF SUMMARY OF THE INVENTION

In view of extending the illumination applications of LEDs, many researchers have devoted themselves to explore various optical lenses to acquire a more uniform illumination distribution on the illuminating area. The present invention provides an optical lens with a free surface different from those of the related arts, capable of enabling a high-directional radiant light-emitting diode to emit a uniform scattering light and providing an illuminating area with a uniform luminance distribution.

The present invention further provides a light-emitting diode optical component and a light-emitting diode illumination lamp which are equipped with the optical lens.

The present invention provides an optical lens formed as a semi-spherical shape, comprising an uplifting spherical surface and a bottom surface corresponding to the spherical surface, wherein the bottom surface includes an inward space concave to the spherical surface and formed with a free surface corresponding to the spherical surface, a center of the bottom surface included with a focus, and the free surface is axially-symmetrical formed as rotational molding with respect to an axis connected from the focus to a center point of the spherical surface. The free surface includes a first curvature section gradually extended and concave to the spherical surface from a center of the free surface toward the bottom surface of the optical lens and a second curvature section smoothly connected to the first curvature section and concave to the inward space, to form the free surface with a similar Gaussian distribution curve provided on a section vertically cut from the spherical surface to the bottom surface.

The present invention provides a light-emitting diode optical component, comprising the optical lens and a light-emitting diode disposed below the focus of the optical lens.

The present invention provides a light-emitting diode illumination lamp using the light-emitting diode optical component, comprising a plurality of light-emitting diode optical components regularly arranged and connected therebetween.

Further, the light-emitting diode optical components are linearly arranged on a lamp seat.

Further, the light-emitting diode optical components are linearly arranged, and the optical lens is integrally formed on a connection plate.

Further, the light-emitting diode optical components are arranged in matrix on a lamp seat.

Further, the light-emitting diode optical components are arranged in matrix, and the optical lens is integrally formed on a connection plate.

Further, the light-emitting diode optical components are concentrically arranged on a lamp seat.

Further, the light-emitting diode optical components are concentrically arranged, and the optical lens is integrally formed on a connection plate.

With the design of the particular free surface of the optical lens, the optical light radiation field can have a uniform light emitting surface scattered from a high-directional radiant light-emitting diode to provide an illuminating area with a uniform luminance distribution.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective view of an optical lens of the invention;

FIG. 2 is a sectional view showing a bonding state of an optical lens and a light-emitting diode of the invention;

FIG. 3 is a schematic view showing incident lights in different directions entering an optical lens of an embodiment of the invention;

FIG. 4 is a schematic view of a first type of a light-emitting diode illumination lamp of the invention;

FIG. 5 is a schematic view of a second type of a light-emitting diode illumination lamp of the invention;

FIG. 6 is a schematic view of a third type of a light-emitting diode illumination lamp of the invention;

FIG. 7 is a schematic view showing an optical lens bonded to a lamp seat of the invention;

FIG. 8 is a schematic view showing an optical lens integrally formed on a connection plate of the invention; and

FIG. 9 shows a numerical analytical simulation diagram of the luminance of a light-emitting diode optical component of the invention.

### DETAILED DESCRIPTION OF THE INVENTION

The following description is of the best-contemplated mode of carrying out the invention. This description is made for the purpose of illustrating the general principles of an optical lens, a light-emitting diode (LED) optical component and a light-emitting diode (LED) illumination lamp of the invention and should not be taken in a limiting sense. The scope of the invention is best determined by reference to the appended claims.

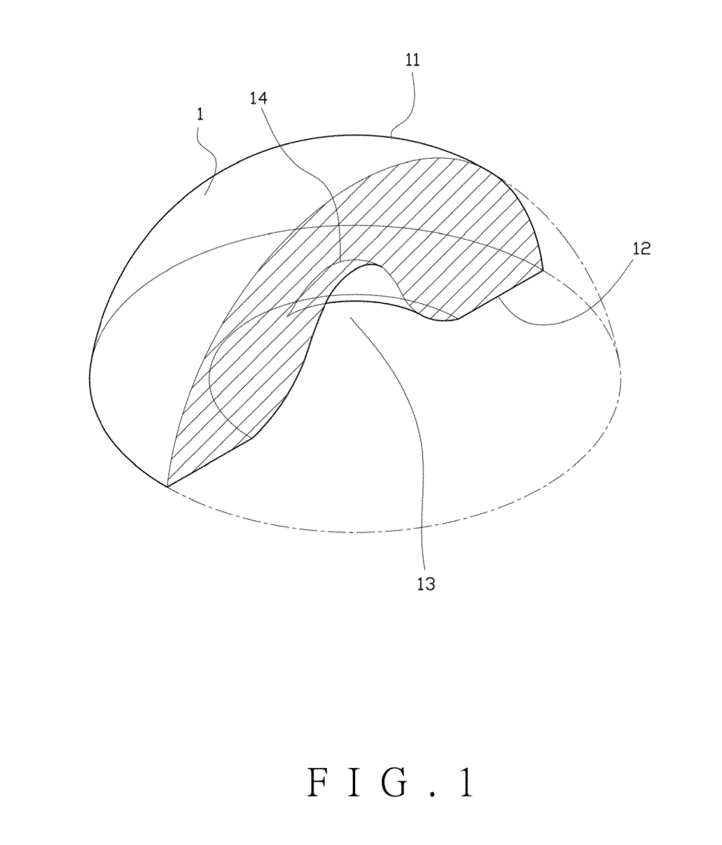

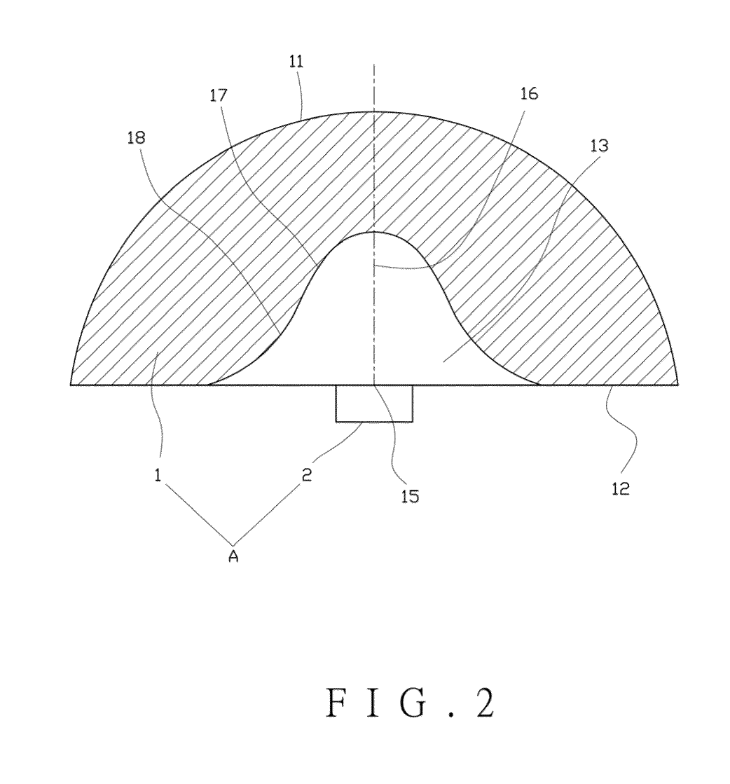

Referring to FIGS. 1 and 2, a LED component ‘A’ comprises an optical lens 1 and a LED 2 bonded to the optical lens 1. The optical lens 1 formed as a semi-spherical shape comprises an uplifting spherical surface 11 and a bottom surface 12 corresponding to the spherical surface 11, wherein the bottom surface 12 includes an inward space 13 concave to the spherical surface 11 and formed with a free surface 14 corresponding to the spherical surface 11, a center of the bottom surface 12 is included with a focus 15, and the free surface 14 is axially-symmetrical formed as rotational molding with respect to an axis 16 connected from the focus 15 to a center point of the spherical surface 11. The free surface 14 includes a first curvature section 17 gradually extended and concave to the spherical surface 11 from a center of the free surface 14 toward the bottom surface 12 of the optical lens 1 and a second curvature section 18 smoothly connected to the first curvature section 17 and concave to the inward space 13, to form the free surface 14 with a similar Gaussian distribution curve provided on a section vertically cut from the spherical surface 11 to the bottom surface 12. The LED 2 is disposed below the focus of the optical lens 1 to cause an optical axis thereof passing through the axis 16.

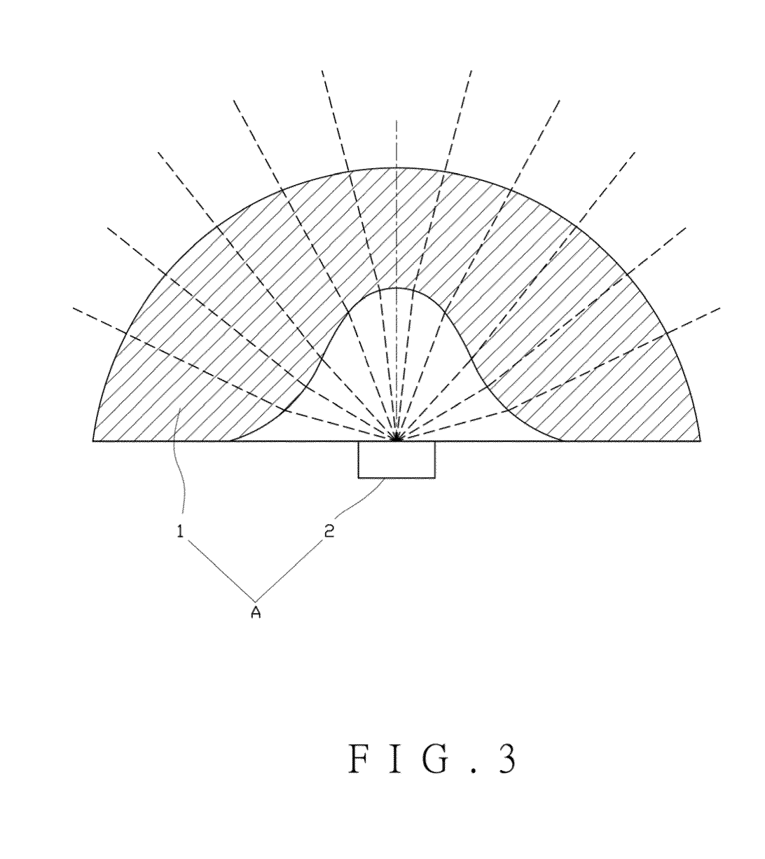

Referring to FIG. 3, when the lights emitted from the LED 2 enter the optical lens 1 at different directions, the lights from the LED 2 can be uniformly scattered by the optical lens 1.

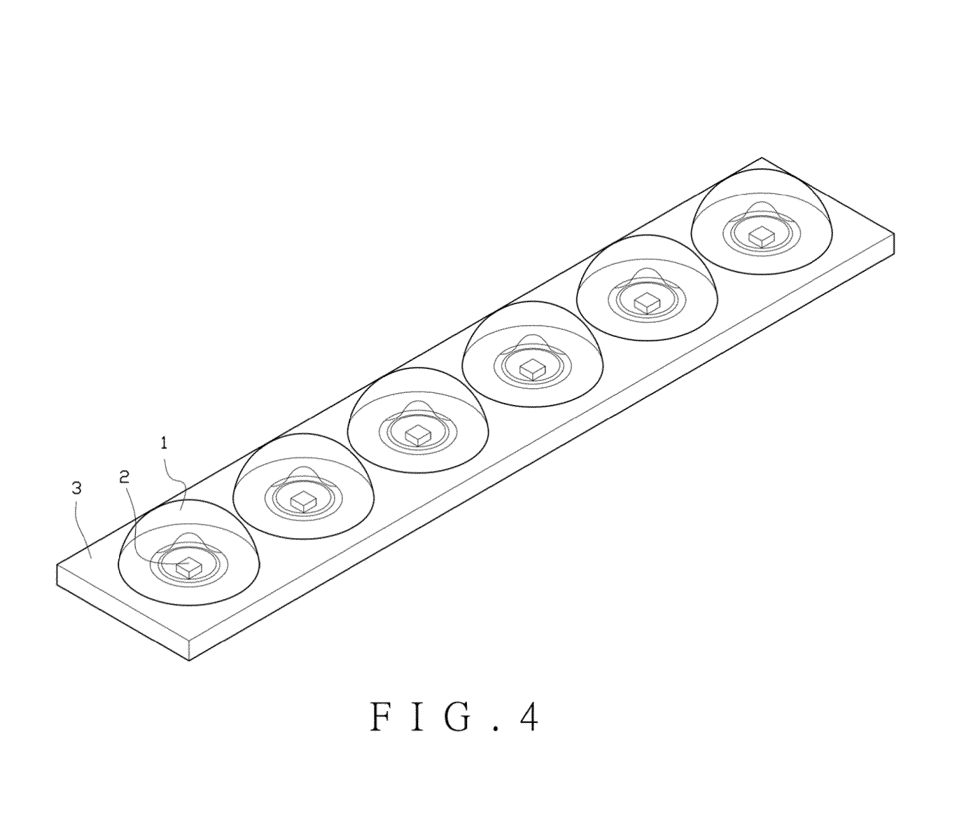

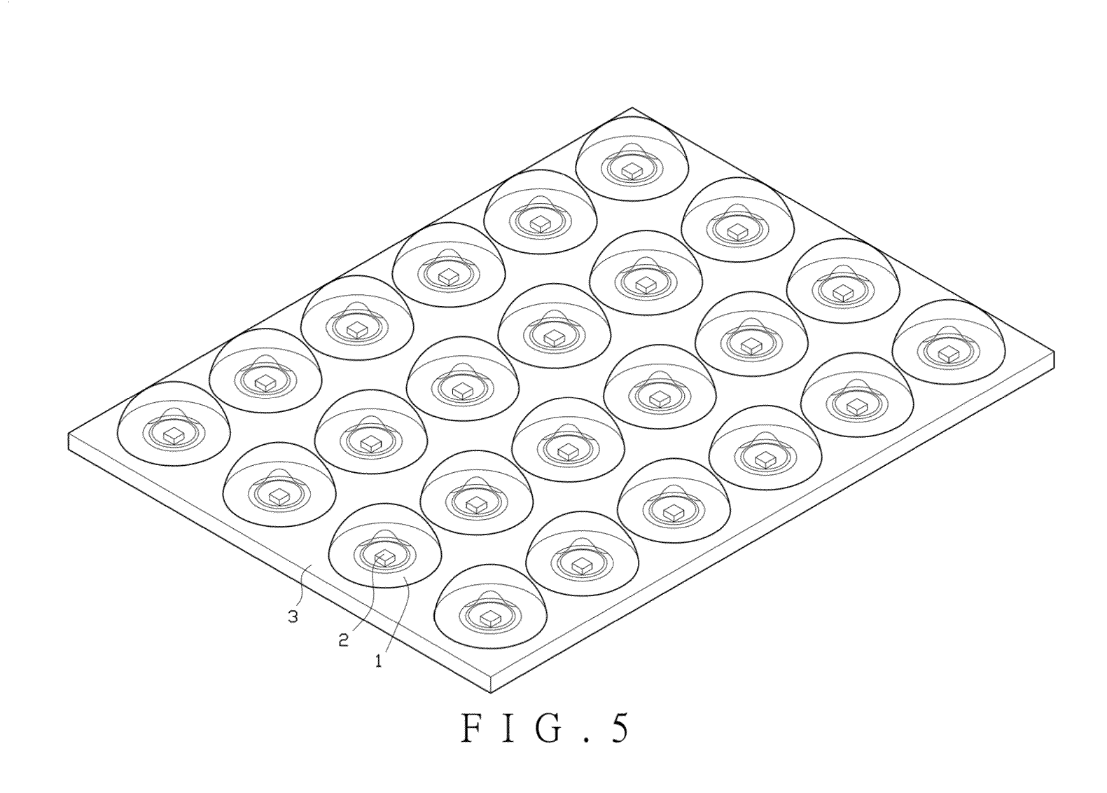

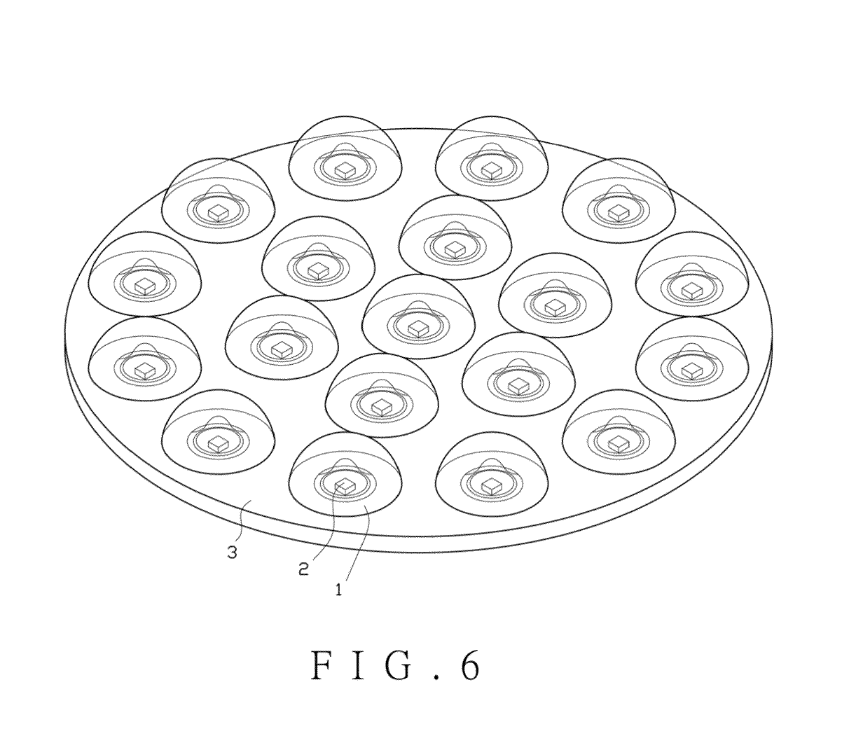

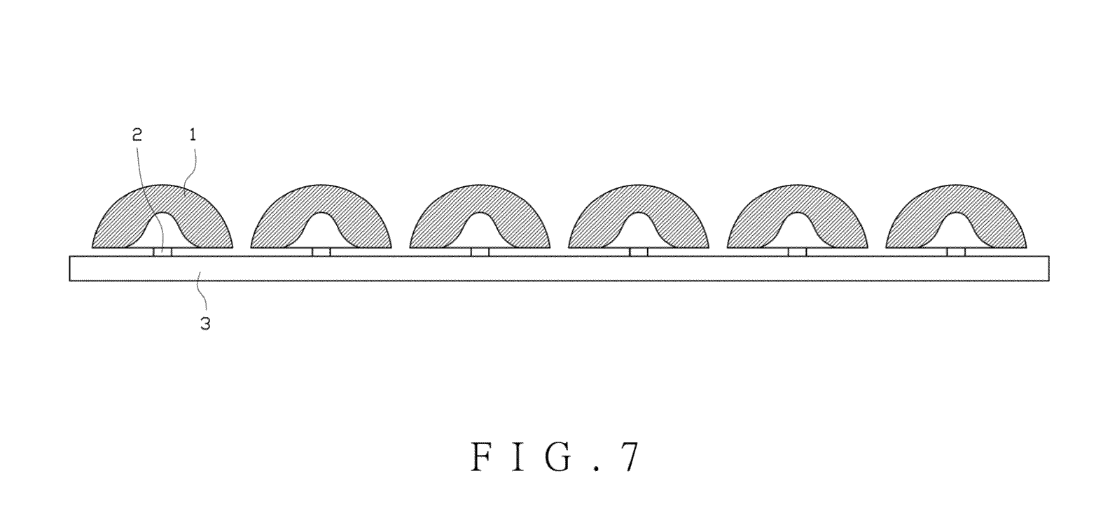

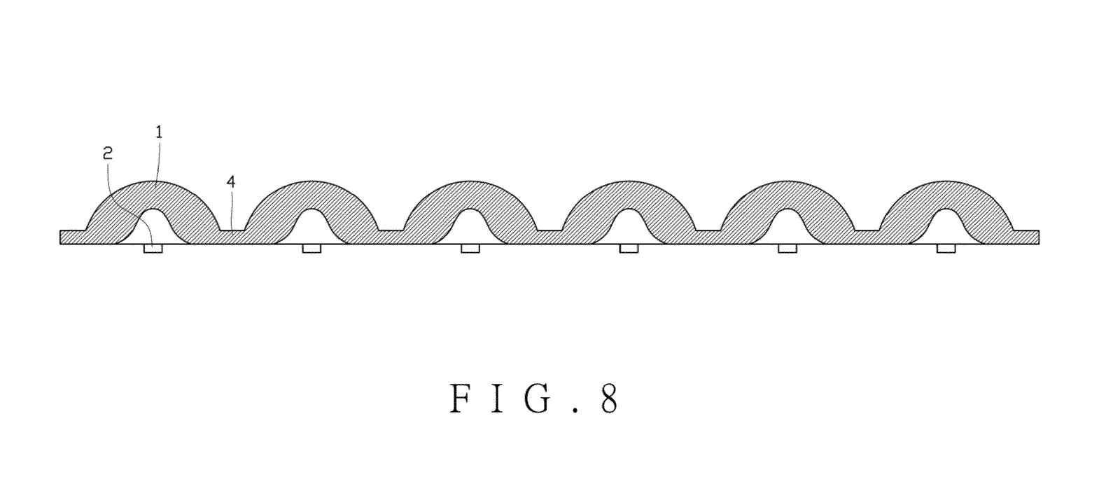

As shown in FIGS. 4, 5, 6 and 7, the LED illumination lamp comprises a plurality of LED components ‘A’ which are regularly arranged. Preferably, the LED components ‘A’ are linearly arranged, arranged in matrix, or concentrically arranged on a lamp seat 3. Further, as shown in FIG. 8, the optical lens 1 is integrally formed on a connection plate 4, thereby simplifying the manufacturing process. The LED lamp can be used for the lighting equipment such as table lamps or fluorescent lamps.

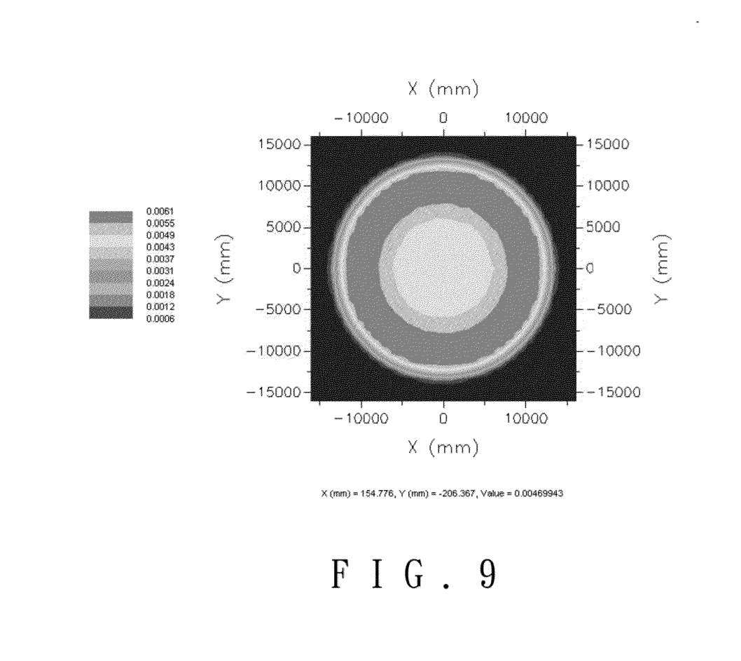

FIG. 9 shows a numerical analytical simulation diagram of the luminance of the LED component ‘A’ of the invention. The LED component ‘A’ of the invention is imported in an optical simulation software to perform light tracing, wherein the distance from a target to the light source of the LED 2 is one meter, and the maximum radius of the target is one meter. It is verified that a similar rounded and uniform luminance distribution of FIG. 9 is suitably intended for the lighting equipment.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical lens formed as a semi-spherical shape, comprising an uplifting spherical surface and a bottom surface corresponding to the spherical surface, the bottom surface including an inward space concave to the spherical surface and formed with a free surface corresponding to the spherical surface, a center of the bottom surface included with a focus, the free surface being axially-symmetrical formed as rotational molding with respect to an axis connected from the focus to a center point of the spherical surface, the free surface including a first curvature section gradually extended and concave to the spherical surface from a center of the free surface toward the bottom surface of the optical lens and a second curvature section smoothly connected to the first curvature section and concave to the inward space, to form the free surface with a similar Gaussian distribution curve provided on a section vertically cut from the spherical surface to the bottom surface.

2. A light-emitting diode optical component, comprising:
an optical lens formed as a semi-spherical shape, comprising an uplifting spherical surface and a bottom surface corresponding to the spherical surface, the bottom surface including an inward space concave to the spherical surface and formed with a free surface corresponding to the spherical surface, a center of the bottom surface included with a focus, the free surface being axially-symmetrical formed as rotational molding with respect to an axis connected from the focus to a center point of the spherical surface, the free surface including a first curvature section gradually extended and concave to the spherical surface from a center of the free surface toward the bottom surface of the optical lens and a second curvature section smoothly connected to the first curvature section and concave to the inward space, to form the free surface with a similar Gaussian distribution curve provided on a section vertically cut from the spherical surface to the bottom surface; and
a light-emitting diode disposed below the focus of the optical lens.

3. A light-emitting diode illumination lamp using the light-emitting diode optical component as claimed in claim 2, comprising a plurality of light-emitting diode optical components regularly arranged and connected therebetween.

4. The light-emitting diode illumination lamp as claimed in claim 3, wherein the light-emitting diode optical components are linearly arranged on a lamp seat.

5. The light-emitting diode illumination lamp as claimed in claim 3, wherein the light-emitting diode optical components are linearly arranged, and the optical lens is integrally formed on a connection plate.

6. The light-emitting diode illumination lamp as claimed in claim 3, wherein the light-emitting diode optical components are arranged in matrix on a lamp seat.

7. The light-emitting diode illumination lamp as claimed in claim 3, wherein the light-emitting diode optical components are arranged in matrix, and the optical lens is integrally formed on a connection plate.

8. The light-emitting diode illumination lamp as claimed in claim 3, wherein the light-emitting diode optical components are concentrically arranged on a lamp seat.

9. The light-emitting diode illumination lamp as claimed in claim 3, wherein the light-emitting diode optical components are concentrically arranged, and the optical lens is integrally formed on a connection plate.
